(19) United States
(12) Patent Application Publication
(10) Pub. No.: US 2017/0313618 A1
(43) Pub. Date: Nov. 2, 2017

(54) GLASS TREATMENT

(71) Applicant: PILKINGTON GROUP LIMITED, LATHOM (GB)

(72) Inventors: KEVIN DAVID SANDERSON, SKELMERSDALE (GB); LEO JAMES PYRAH, ALTRINCHAM (GB); DAVID ALAN STRICKLER, TOLEDO, OH (US); NEIL MCSPORRAN, PERRYSBURG, OH (US)

(73) Assignee: PILKINGTON GROUP LIMITED, LATHOM (GB)

(21) Appl. No.: 15/520,428

(22) PCT Filed: Oct. 21, 2015
(86) PCT No.: PCT/GB2015/053134

§ 371 Date: Apr. 20, 2017

Related U.S. Application Data
(60) Provisional application No. 62/066,480, filed on Oct. 21, 2014.

(51) Int. Cl. C03C 17/245; C03C 15/02; C03C 17/36; C03C 23/00; C03C 17/34

(52) U.S. Cl. CPC C03C 17/2453; C03C 23/008; C03C 17/3417; C03C 17/3644; C03C 15/02; C03C 2217/944; C03C 2217/948; C03C 2218/33

(57) ABSTRACT

A method is disclosed, for removal of tin deposits from a glass substrate during a float glass manufacturing process. An acidic gas, such as hydrogen fluoride, is delivered to the substrate surface using chemical vapour deposition apparatus.

This invention relates to a method of removing tin from the surface of a float glass substrate and the use of an acidic gas to remove tin from the surface of a float glass substrate.

The manufacture of flat glass by the float process involves delivering glass at a controlled rate onto a bath of molten tin and advancing it along the surface of the bath under physical and thermal conditions which (1) assure that a layer of molten glass will be established on the bath, (2) that the glass in the layer can flow laterally to develop on the surface of the bath a buoyant body of molten glass of stable thickness, and (3) that the buoyant body in ribbon forth will be continuously advanced along the bath and sufficiently cooled as it advances to permit it to be taken unharmed out of the bath by mechanical conveying means. Above the float bath of molten tin, a superstructure forming a tightly enclosed headspace or plenum chamber is provided to contain a so-called float atmosphere.

In order to provide float glass with the desired surface finish it is essential that no foreign matter of any kind is permitted to adhere to or accumulate on the upper or exposed surface of the float glass ribbon. However, considerable difficulty has been experienced with a defect known as “tin drop” which results from droplets of molten tin falling or dripping from the superstructure forming the ceiling of the plenum chamber onto the surface of the newly formed hot glass ribbon. The tin droplets are formed via the evaporation of molten tin (from the areas of the float bath that are exposed to the float atmosphere on either side of the glass ribbon) which then condenses or deposits in the open pores of the refractory surfaces inside the plenum chamber. As the pores are closed, the tin deposits primarily as individual globules, which on the ceiling of the chamber coalesce to a size large enough to cause them to drip onto the glass ribbon. This phenomenon results in glass ribbons having droplets of metal on and/or embedded in their upper surfaces, creating defects such as voids in subsequently coated products. These defects bring about a reduction in yield due to the rejection of sizable areas of the ribbon for commercial use.

Known approaches to try to address this problem include preventive measures such as the removal of tin deposits from the superstructure by introducing a fluxing agent, e.g. a halogen or halide, which causes the tin deposits to coalesce and drop onto the glass ribbon at controlled occasions (see U.S. Pat. No. 4,019,885). There are also reactive methods in the art, for instance the removal of foreign matter from the surface of a float glass substrate by immersing the glass in an aqueous solution of hydrofluoric acid or in an acidic aqueous solution containing a bivalent chromium ion followed by polishing of the glass surface (see JP 9295833 A).

However, neither of these approaches allow for the continuous on-line production of defect-free glass because the method of U.S. Pat. No. 4,019,885 requires that the glass produced during the treatment is scrapped, whilst the procedure of JP 9295833 A necessitates additional off-line processing of the glass.

According to a first aspect of the present invention there is provided a method of removing tin from a surface of a float glass substrate comprising at least the following steps in sequence:

a) providing a float glass substrate that directly or indirectly bears one or more tin deposits on a major surface thereof, and
b) removing at least a portion of said tin deposits from said surface of the substrate by reacting said tin deposits with an acidic gas that is introduced via a Chemical Vapour Deposition (CVD) apparatus.

It has surprisingly been found that tin deposits can be conveniently and effectively removed from the surface of a glass substrate during the float process using an acidic gas delivered by CVD. It is understood that there are two possible reactions at work during this method:

Sn+2HF→SnF₂+H₂ 1)

SnF₂ has a boiling point of 850° C., but probably has a significant vapour pressure at 600-700° C., and therefore the reacted tin may depart as SnF₂ gas.

Sn+4HF→SnF₄+2H₂ 2)

SnF₄ is polymeric so it does not melt until 700° C., and then it decomposes before reaching a distinct boiling point. Therefore if SnF₄ forms, it probably decomposes and the reacted tin is carried away as SnF₂ gas.

Delivering the acidic gas via CVD enables the continuous removal of tin deposits during the float process, for instance as part of a coating run. The acidic gas can be introduced in a controlled manner in extremely close proximity to the glass substrate. Therefore the method of the present invention provides an advantageous approach to reducing defects observable through float glass substrates caused by tin deposits, particularly if the substrates are coated either before or after removal of at least a portion of the tin deposits. Furthermore the present invention provides clear benefits over approaches such as the preventative float bath chlorination of U.S. Pat. No. 4,019,885.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

In the context of the present invention, where a layer is said to be “based on” a particular material or materials, this means that the layer predominantly consists of the corresponding said material or materials, which means typically that it comprises at least about 50 at. % of said material or materials.

Preferably the acidic gas comprises one or more of a fluorine- or chlorine-containing acid such as I-IF and/or HCl. More preferably the acidic gas comprises a fluorine-containing acid, most preferably HF. The acidic gas may further comprise water vapour, the presence of which can help control the tin removal process. The ratio of the volume of water vapour to the volume of acid in the acidic gas is preferably at least 0.1, more preferably at least 0.5, even more preferably at least 1.0, most preferably at least 1.5, but preferably at most 40, more preferably at most 30, even more preferably at most 20, most preferably at most 10.

Preferably any steps carried out using CVD involve the preparation of a precursor gas mixture. Preferably step b) is carried out using a precursor gas mixture comprising HF and/or HCl, and water, more preferably comprising HF and water. The precursor gas mixture may further comprise a carrier gas or diluents, for example, nitrogen, air and/or helium, preferably nitrogen.

In certain embodiments, the acidic gas and/or precursor gas mixture is fed through a CVD apparatus and then discharged from the apparatus utilizing one or more gas distributor beams. Preferably, the acidic gas and/or precursor gas mixture is formed prior to being fed through the CVD apparatus. For example, the acidic gas and/or precursor compounds may be mixed in a feed line connected to an inlet of the CVD apparatus. In other embodiments, the acidic gas and/or precursor gas mixture may be formed within the CVD apparatus.

Preferably the method of the present invention is carried out during the float glass manufacturing process. Preferably the CVD apparatus extends transversely across the glass substrate and is provided at a predetermined distance above the substrate. When the method is carried out during the float glass manufacturing process, the CVD apparatus is preferably provided within a float bath section thereof. However, the CVD apparatus may be provided in an annealing lehr, and/or in a gap between the float bath and an annealing lehr. The preferred method of CVD is atmospheric (or substantially atmospheric) pressure CVD (e.g. online CVD as performed during the float glass process). However, it should be appreciated that step b) can alternatively be utilized apart from the float glass manufacturing process, or well after formation and cutting of the glass substrate. Descriptions of CVD apparatuses suitable for being utilized in the method can be found in U.S. Ser. No. 13/426,697 and U.S. Pat. No. 4,922,853. Preferably the method of the present invention is a dynamic process in which the glass substrate is moving during step b), more preferably during the entire method. Preferably, the glass substrate moves at a predetermined rate of, for example, greater than 3.175 m/min during step b) and/or step c). More preferably the glass substrate is moving at a rate of between 3.175 m/min and 12.7 m/min during step b) and/or step c). Alternatively or additionally the CVD apparatus movably directs the acidic gas towards and along the surface of the glass substrate. Preferably, the acidic gas is directed towards and along the glass substrate in a laminar flow.

Step b) may preferably be carried out when the glass substrate is at a temperature in the range 450° C. to 800° C., more preferably when the glass substrate is at a temperature in the range 550° C. to 700° C. The temperature may depend on the position of the CVD apparatus in a float bath, the specific CVD apparatus used, and/or the type of glass substrate (e.g. thinner glass may be at a higher temperature than thick glass in the same float bath). It can be advantageous, particularly in the case of substrates that are coated with at least one layer located between said major surface and said one or more tin deposits, to use these preferred temperatures because they help to ensure that any SnF₂ or SnF₄ that is formed is volatile enough to disperse rather than remain on the surface.

As detailed above, preferably the CVD is carried out during the float glass process at substantially atmospheric pressure. Alternatively the CVD may be carried out using low-pressure CVD or ultrahigh vacuum CVD. The CVD may be carried out using aerosol assisted CVD or direct liquid injection CVD. Furthermore, the CVD may be carried out using microwave plasma-assisted CVD, plasma-enhanced CVD, remote plasma-enhanced CVD, atomic layer CVD, combustion CVD (flame pyrolysis), hot wire CVD, metalorganic CVD, rapid thermal CVD, vapour phase epitaxy, or photo-initiated CVD. The glass substrate will usually be cut into sheets after step b) and after deposition of any CVD coating(s) (and before deposition of any Physical Vapour Deposition (PVD) coatings) for storage or convenient transport from the float glass production facility possibly to a vacuum deposition facility.

Step b) and/or any subsequent CVD may also comprise forming a gaseous mixture. As would be appreciated by those skilled in the art, the precursor compounds suitable for use in the gaseous mixture should be suitable for use in a CVD process. Such compounds may at some point be a liquid or a solid but are volatile such that they can be vaporised for use in a gaseous mixture. Once in a gaseous state, the precursor compounds can be included in a gaseous stream and utilized in a CVD process to carry out step b) and/or any subsequent CVD. For any particular combination of gaseous precursor compounds, the optimum concentrations and flow rates for achieving a particular tin removal/deposition rate and/or coating thickness may vary.

The glass substrate may be a soda-lime-silica glass substrate. However, the method is not limited to a soda-lime-silica glass substrate as, in other embodiments, the glass substrate may be a borosilicate glass. Additionally, or alternatively, it may be preferable to utilize a glass substrate having a low iron content.

The glass substrate may be substantially transparent. However, the invention is not limited to transparent glass substrates as translucent glass substrates may also be utilized in practicing the method. Also, the transparency or absorption characteristics of the substrate may vary between embodiments. Additionally, the method can be practiced utilizing a clear or a coloured glass substrate and is not limited to a particular glass substrate thickness.

The method may further comprise polishing said surface of the glass substrate following step b). The surface may be polished using brushes and/or pads, potentially with the addition of a polishing slurry.

The major surface of the float glass substrate of step a) may be coated with at least one layer located between said major surface and said one or more tin deposits. Alternatively or additionally the method may further comprise depositing at least one layer on the surface of the substrate following step b). Said at least one layers may comprise at least one layer based on a transparent conductive coating (TCC). Preferably the TCC is a transparent conductive oxide (TCO). Preferably the TCO is one or more of fluorine doped tin oxide (SnO₂:F), zinc oxide doped with aluminium, gallium or boron (ZnO:Al, ZnO:Ga, ZnO:B), indium oxide doped with tin (ITO), cadmium stannate, ITO:ZnO, ITO:Ti, In₂O₃, In₂O₃—ZnO (IZO), In₂O₃:Ti, In₂O₃:Mo, In₂O₃:Ga, In₂O₃:W, In₂O₃:Zr, In₂O₃:Nb, In₂₋₂ₓMₓSnₓO₃ with M being Zn or Cu, ZnO:F, Zn_{0.9}Mg_{0.1}O:Ga, (Zn,Mg)O:P, ITO:Fe, SnO₂:Co, In₂O₃:Ni, In₂O₃:(Sn,Ni), ZnO:Mn, and/or ZnO:Co.

Preferably each layer of the at least one layer based on a TCC has a thickness of at least 20 nm, more preferably at least 100 nm, even more preferably at least 200 nm, even more preferably at least 250 nm, most preferably at least 300 nm; but preferably at most 600 nm, more preferably at most 450 nm, even more preferably at most 370 nm, most preferably at most 350 nm. These thicknesses are preferred in order to strike a balance between the properties of 1) conductivity 2) absorption (the thicker the layer the more absorption and the lower the transmission) and 3) colour suppression (certain thicknesses are better for obtaining a neutral colour).

The major surface of the float glass substrate of step a) may alternatively or additionally be coated with at least one layer based on an oxide of a metal or of a metalloid, such as SiO₂, SnO₂, TiO₂, silicon oxynitride and/or aluminium oxide, located between said major surface and said one or more tin deposits. Alternatively or additionally the method may further comprise depositing at least one layer based on an oxide of a metal or of a metalloid, such as SiO₂, SnO₂, TiO₂, silicon oxynitride and/or aluminium oxide following step b). One layer of said at least one layer based on an oxide of a metal or of a metalloid is preferably located in direct contact with said major surface of said glass substrate. Additionally, or alternatively, one layer of said at least one layer based on an oxide of a metal or of a metalloid is preferably located in direct contact with the layer based on a TCC. Such a layer based on an oxide of a metal or of a metalloid may act as a blocking layer to prevent the diffusion of sodium ions to the surface, which can be a source of corrosion, or it may act as a colour suppression layer to suppress iridescent reflection colours resulting from variations in thickness of the layers. Preferably each layer of the at least one layer based on an oxide of a metal or of a metalloid has a thickness of at least 5 nm, more preferably at least 10 nm, even more preferably at least 15 nm, most preferably at least 20 nm; but preferably at most 100 nm, more preferably at most 50 nm, even more preferably at most 40 nm, most preferably at most 30 nm.

The major surface of the float glass substrate of step a) may alternatively or additionally be coated with, in sequence from the glass substrate and located between said major surface and said one or more tin deposits:

at least one layer based on SnO₂,
at least one layer based on SiO₂, and
at least one layer based on SnO₂:F,
wherein the at least one layer based on SnO₂ has a thickness of at least 15 nm, but at most 35 nm,
wherein the at least one layer based on SiO₂ has a thickness of at least 15 nm, but at most 35 nm, and
wherein the at least one layer based on SnO₂:F has a thickness of at least 300 nm, but at most 600 nm.

Alternatively or additionally, in some embodiments the method may further comprise, following step b), depositing in sequence on the glass substrate:

at least one layer based on SnO₂,
at least one layer based on SiO₂, and
at least one layer based on SnO₂:F,
wherein the at least one layer based on SnO₂ has a thickness of at least 15 nm, but at most 35 nm,
wherein the at least one layer based on SiO₂ has a thickness of at least 15 nm, but at most 35 nm, and
wherein the at least one layer based on SnO₂:F has a thickness of at least 300 nm, but at most 600 nm.

Preferably the at least one layer based on SnO₂ has a thickness of at least 20 nm, more preferably at least 23 nm, even more preferably at least 24 nm, but preferably at most 30 nm, more preferably at most 27 nm, even more preferably at most 26 nm.

Preferably the at least one layer based on SiO₂ has a thickness of at least 20 nm, more preferably at least 23 nm, even more preferably at least 24 nm, but preferably at most 30 nm, more preferably at most 27 nm, even more preferably at most 26 nm.

Preferably the at least one layer based on SnO₂:F has a thickness of at least 320 nm, more preferably at least 330 nm, even more preferably at least 335 nm, but preferably at most 400 nm, more preferably at most 360 nm, even more preferably at most 350 nm, even more preferably at most 345 nm.

The at least one layer based on a TCC and/or the at least one layer based on an oxide of a metal or of a metalloid are preferably deposited using CVD. For the deposition of SnO₂ via CVD the precursor gas mixture preferably comprises dimethyl tin dichloride (DMT), oxygen and steam. The same mixture can be used to deposit SnO₂:F provided a source of flurorine is added, such as HF. For the deposition of silica the precursor gas mixture may comprise silane (SiH₄) and ethylene (C₂H₄). For the deposition of titania the precursor gas mixture may comprise titanium tetrachloride (TiCl₄) and ethyl acetate (EtOAc). Preferably the precursor gas mixtures comprise nitrogen. In some embodiments the precursor gas mixture may also comprise helium.

The major surface of the float glass substrate of step a) may alternatively or additionally be coated with, in sequence from the glass substrate and located between said major surface and said one or more tin deposits:

a lower anti-reflection layer,
a silver-based functional layer; and
at least one further anti-reflection layer.

Alternatively or additionally, in some embodiments the method may further comprise, following step b), depositing in sequence on the glass substrate:

a lower anti-reflection layer,
a silver-based functional layer; and
at least one further anti-reflection layer.

The lower and/or further anti-reflection layer may comprise at least one dielectric layer based on an (oxy)nitride of Si and/or an (oxy)nitride of Al and/or alloys thereof; and/or based on a metal oxide such as an oxide of one or more of Ti, Zr, Zn, Sn, In, and/or Nb, such as an oxide of Zn and Sn. Said dielectric layers may preferably have a thickness of at least 1 nm, more preferably at least 2 nm, even more preferably at least 5 nm, most preferably at least 10 nm; but preferably at most 70 nm, more preferably at most 50 nm, even more preferably at most 40 nm, most preferably at most 30 nm.

The at least one further anti-reflection layer preferably further comprises at least one barrier layer. Preferably said barrier layer is located in direct contact with the silver-based functional layer. Preferably said barrier layer is based on NiCr, Nb, Ti, Zr, Zn, Sn, In, and/or Cr and/or their oxides and/or nitrides. The at least one barrier layer may preferably have a total thickness of at least 0.5 nm, more preferably at least 1 nm, even more preferably at least 3 nm, most preferably at least 5 nm; but preferably at most 12 nm, more preferably at most 10 nm, even more preferably at most 8 nm, most preferably at most 7 nm. These preferred thicknesses enable further ease of deposition and improvement in optical characteristics such as haze whilst retaining mechanical durability.

In some embodiments the method may further comprise depositing more than one silver-based functional layer. For example, the method may further comprise depositing two, three or more silver-based functional layers. When the method further comprises depositing more than one silver-based functional layer, each silver-based functional layer may be spaced apart from an adjacent silver-based functional layer by a central anti-reflection layer.

The lower anti-reflection layer, the silver-based functional layer, and/or the further anti-reflection layer are preferably deposited using PVD. Preferably the PVD is carried out by sputter deposition. It is particularly preferred that the PVD is magnetron cathode sputtering, either in the DC mode, in the pulsed mode, in the medium or radio frequency mode or in any other suitable mode, whereby metallic or semiconducting targets are sputtered reactively or non-reactively in a suitable sputtering atmosphere. Depending on the materials to be sputtered, planar or rotating tubular targets may be used. The coating process is preferably carried out by setting up suitable coating conditions such that any oxygen (or nitrogen) deficit of any oxide (or nitride) layer of any layers of the coating is kept low to achieve a high stability of the visible light transmittance and colour of the coated glazing, particularly during a heat treatment.

Heat treated glass panes which are toughened to impart safety properties and/or are bent are required for a large number of areas of application. It is known that for thermally toughening and/or bending glass panes it is necessary to process the glass panes by a heat treatment at temperatures near or above the softening point of the glass used and then either to toughen them by rapid cooling or to bend them with the aid of bending means. The relevant temperature range for standard float glass of the soda lime silica type is typically about 580-690° C., the glass panes being kept in this temperature range for several minutes before initiating the actual toughening and/or bending process. The terms “heat treatment”, “heat treated” and “heat treatable” refer to thermal bending and/or toughening processes such as mentioned above and to other thermal processes during which a coated glass pane reaches temperatures in the range of about 580-690° C. for a period of, e.g., about 5 minutes, preferably for about 10 minutes. A coated glass pane is deemed to be heat treatable if it survives a heat treatment without significant damage, typical damages caused by heat treatments being high haze values, pinholes or spots. Preferably a coated glass substrate that is produced according to the method of the present invention is heat treatable.

In some embodiments the method may further comprise depositing at least one opposing layer on an opposing major surface of the glass pane (i.e. not the major surface referred to in the first aspect). Said at least one opposing layer may be based on one or more of the materials listed above for: the at least one layer based on a TCC, the at least one layer based on an oxide of a metal or of a metalloid, the lower anti-reflection layer, the silver-based functional layer, and/or the further anti-reflection layer. Said at least one opposing layer may be deposited before or after step b).

According to a second aspect of the present invention there is provided a glass substrate produced by the method according to the first aspect.

According to a third aspect of the present invention there is provided the use of an acidic gas introduced via a CVD apparatus to remove at least a portion of one or more tin deposits from a major surface of a float glass substrate.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention will now be further described by way of the following specific embodiments, which are given by way of illustration and not of limitation, with reference to the accompanying drawings in which:

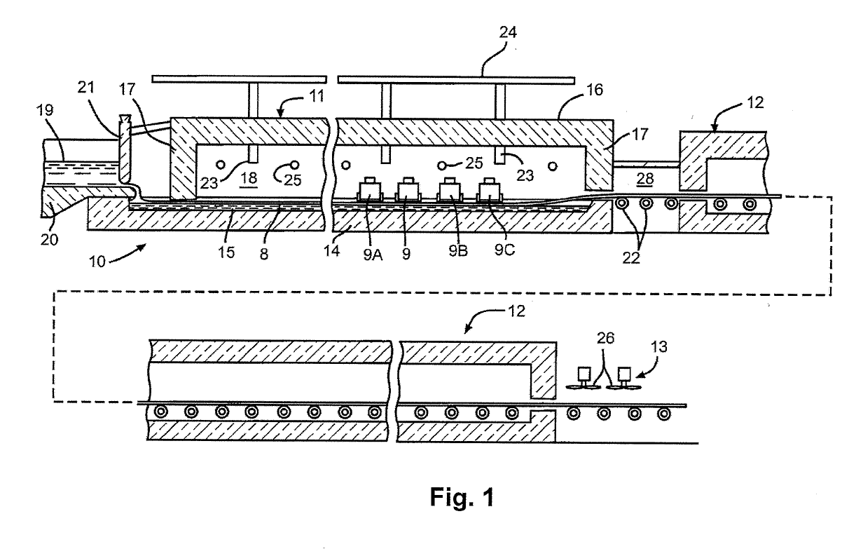

FIG. 1 is a schematic view, in vertical section, of an installation for practicing the float glass process which incorporates several CVD apparatuses for carrying out the present invention.

As discussed above, the removal of tin deposits from a surface of a float glass substrate by reacting with an acidic gas that is introduced via a CVD apparatus may be carried out in conjunction with the manufacture of the glass substrate in the float glass process. The float glass process is typically carried out utilizing a float glass installation such as the installation 10 depicted in FIG. 1. However, it should be understood that the float glass installation 10 described herein is only illustrative of such installations.

As illustrated in FIG. 1, the float glass installation 10 may comprise a canal section 20 along which molten glass 19 is delivered from a melting furnace, to a float bath section 11 wherein the glass substrate is formed. In this embodiment, the glass substrate will be referred to as a glass ribbon 8. However, it should be appreciated that the glass substrate is not limited to being a glass ribbon. The glass ribbon 8 advances from the bath section 11 through an adjacent annealing lehr 12 and a cooling section 13. The float bath section 11 includes: a bottom section 14 within which a bath of molten tin 15 is contained, a roof 16, opposite side walls (not depicted) and end walls 17. The roof 16, side walls and end walls 17 together define an enclosure 18 in which a non-oxidizing atmosphere is maintained to prevent oxidation of the molten tin 15.

In operation, the molten glass 19 flows along the canal 20 beneath a regulating tweel 21 and downwardly onto the surface of the tin bath 15 in controlled amounts. On the molten tin surface, the molten glass 19 spreads laterally under the influence of gravity and surface tension, as well as certain mechanical influences, and it is advanced across the tin bath 15 to form the glass ribbon 8. The glass ribbon 8 is removed from the bath section 11 over lift out rolls 22 and is thereafter conveyed through the annealing lehr 12 and the cooling section 13 on aligned rolls. The removal of the tin deposits preferably takes place in the float bath section 11, although it may be possible for the removal to take place further along the glass production line, for example, in the gap 28 between the float bath 11 and the annealing lehr 12, or in the annealing lehr 12.

As illustrated in FIG. 1, four CVD apparatuses 9, 9A, 9B, 9C are shown within the float bath section 11. Thus, depending on the frequency and nature of the tin deposits it may be desirable to use one or more than one of the CVD apparatuses 9, 9A, 9B, 9C, whilst any remaining CVD apparatuses may be utilized to form one or more coating layers if desired. A CVD apparatus may alternatively or additionally be located in the lehr gap 28. Any by-products are removed through coater extraction slots and then through a pollution control plant. For example, in an embodiment, tin deposits are removed using CVD apparatus 9A, a tin oxide coating is formed utilizing CVD apparatus 9, a silica coating is formed utilizing an adjacent apparatus 9B and the remaining apparatus 9C is utilized to form a fluorine doped tin oxide coating.

A suitable non-oxidizing atmosphere, generally nitrogen or a mixture of nitrogen and hydrogen in which nitrogen predominates, is maintained in the float bath section 11 to prevent oxidation of the molten tin 15 comprising the float bath. The atmosphere gas is admitted through conduits 23 operably coupled to a distribution manifold 24. The non-oxidizing gas is introduced at a rate sufficient to compensate for normal losses and maintain a slight positive pressure, on the order of between about 0.001 and about 0.01 atmosphere above ambient atmospheric pressure, so as to prevent infiltration of outside atmosphere. For the purposes of describing the invention, the above-noted pressure range is considered to constitute normal atmospheric pressure.

The CVD removal of tin deposits and deposition of coating layers are generally performed at essentially atmospheric pressure. Thus, the pressure of the float bath section 11, annealing lehr 12, and/or in the gap 28 between the float bath 11 and the annealing lehr 12 may be essentially atmospheric pressure. Heat for maintaining the desired temperature regime in the float bath section 11 and the enclosure 18 is provided by radiant heaters 25 within the enclosure 18. The atmosphere within the lehr 12 is typically atmospheric air, as the cooling section 13 is not enclosed and the glass ribbon 8 is therefore open to the ambient atmosphere.

The glass ribbon 8 is subsequently allowed to cool to ambient temperature. To cool the glass ribbon 8, ambient air may be directed against the glass ribbon 8 by fans 26 in the cooling section 13. Heaters (not shown) may also be provided within the annealing lehr 12 for causing the temperature of the glass ribbon 8 to be gradually reduced in accordance with a predetermined regime as it is conveyed therethrough.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1.-18. (canceled)

19. A method of removing tin from a surface of a float glass substrate comprising at least the following steps in sequence:
a) providing a float glass substrate that directly or indirectly bears one or more tin deposits on a major surface thereof, and
b) removing at least a portion of said tin deposits from said surface of the substrate by reacting said tin deposits with an acidic gas that is introduced via a Chemical Vapour Deposition (CVD) apparatus.

20. The method according to claim 19, wherein the acidic gas comprises a fluorine-containing acid, preferably HF.

21. The method according to claim 19, wherein the acidic gas further comprises water vapour.

22. The method according to claim 21, wherein the ratio of the volume of water vapour to the volume of acid in the acidic gas is at least 0.5.

23. The method according to claim 22, wherein the ratio of the volume of water vapour to the volume of acid in the acidic gas is at most 30.

24. The method according to claim 19, wherein step b) is carried out using a precursor gas mixture comprising HF, nitrogen and water.

25. The method according to claim 19, wherein the method is carried out during the float glass manufacturing process.

26. The method according to claim 25, wherein the CVD apparatus is provided within a float bath section.

27. The method according to claim 19, wherein the glass substrate is moving during step b).

28. The method according to claim 19, wherein step b) is carried out when the glass substrate is at a temperature in the range 550° C. to 700° C.

29. The method according to claim 19, wherein the major surface of the float glass substrate of step a) is coated with at least one layer located between said major surface and said one or more tin deposits.

30. The method according to claim 19, wherein the method further comprises depositing at least one layer on the surface of the substrate following step b).

31. The method according to claim 29, wherein said layer comprises at least one layer based on a transparent conductive coating (TCC), wherein the TCC is a transparent conductive oxide (TCO), and wherein the TCO is one or more of fluorine doped tin oxide (SnO₂:F), zinc oxide doped with aluminium, gallium or boron (ZnO:Al, ZnO:Ga, ZnO:B), indium oxide doped with tin (ITO), cadmium stannate, ITO:ZnO, ITO:Ti, In₂O₃, In₂O₃—ZnO (IZO), In₂O₃:Ti, In₂O₃:Mo, In₂O₃:Ga, In₂O₃:W, In₂O₃:Zr, In₂O₃:Nb, In₂₋₂ₓMₓSnₓO₃ with M being Zn or Cu, ZnO:F, Zn_{0.9}Mg_{0.1}O:Ga, (Zn,Mg)O:P, ITO:Fe, SnO₂:Co, In₂O₃:Ni, In₂O₃:(Sn,Ni), ZnO:Mn, and/or ZnO:Co.

32. The method according to claim 19, wherein the major surface of the float glass substrate of step a) is coated with at least one layer based on an oxide of a metal or of a metalloid, located between said major surface and said one or more tin deposits.

33. The method according to claim 19, wherein the major surface of the float glass substrate of step a) is coated with at least one layer based on SiO₂, SnO₂, TiO₂, silicon oxynitride and/or aluminium oxide, located between said major surface and said one or more tin deposits.

34. The method according to claim 19, wherein the method further comprises depositing at least one layer based on an oxide of a metal or of a metalloid following step b).

35. The method according to claim 19, wherein the method further comprises depositing at least one layer based on SiO₂, SnO₂, TiO₂, silicon oxynitride and/or aluminium oxide following step b).

36. The method according to claim 19, wherein the major surface of the float glass substrate of step a) is coated with, in sequence from the glass substrate and located between said major surface and said one or more tin deposits:
a lower anti-reflection layer,
a silver-based functional layer; and
at least one further anti-reflection layer.

37. The method according to claim 19, wherein the method further comprises, following step b), depositing in sequence on the glass substrate:
a lower anti-reflection layer,
a silver-based functional layer; and
at least one further anti-reflection layer.

38. A glass substrate produced by the method according to claim 19.
